(19) United States
(12) Patent Application Publication
(10) Pub. No.: US 2014/0021076 A1
(43) Pub. Date: Jan. 23, 2014

(54) DOUBLE-ENDED NEEDLE AND MIXING INSTRUMENT

(71) Applicant: TERUMO KABUSHIKI KAISHA, Shibuya-ku (JP)

(72) Inventors: Katsuaki SOMA, Shizuoka (JP); Hiroyuki Ishihara, Kanagawa (JP); Teruyuki Yatabe, Kanagawa (JP)

(73) Assignee: TERUMO KABUSHIKI KAISHA, Shibuya-ku (JP)

(21) Appl. No.: 14/035,258

(22) Filed: Sep. 24, 2013

Related U.S. Application Data
(63) Continuation of application No. PCT/JP2012/056054, filed on Mar. 9, 2012.

(30) Foreign Application Priority Data
Mar. 25, 2011 (JP) 2011-066848

(51) Int. Cl. A61J 1/20

(52) U.S. Cl. CPC A61J 1/2089
USPC 206/219; 604/413

(57) ABSTRACT

A double-ended needle and a mixing instrument which are capable of suppressing a reverse flow of a solution are provided. A double-ended needle which constitutes part of a mixing instrument includes a first puncture portion and a second puncture portion having inner cavities thereof communicating with each other, an inner cavity of the first puncture portion and an inner cavity of the second puncture portion communicate with each other, and the lateral cross-sectional area of the inner cavity of the first puncture portion is smaller than the lateral cross-sectional area of the inner cavity of the second puncture portion.

### CROSS REFERENCES TO RELATED APPLICATIONS

This application is a continuation of International Application No. PCT/JP2012/056054 filed on Mar. 9, 2012, and claims priority to Japanese Application No. 2011-066848 filed on Mar. 25, 2011, the entire content of both of which is incorporated herein by reference.

### TECHNICAL FIELD

The present invention relates to a double-ended needle and a mixing instrument for mixing, for example, a solid-state or liquid-state first component and a liquid-state second component.

### BACKGROUND DISCUSSION

In the related art, in medical facilities or the like, for example, in a case of performing drip infusion (transfusion) or administering an adhesion prevention agent or a body tissue adhesive agent to a patient, there is a situation where a medicinal agent is diluted or dissolved with liquid to coordinate a medicinal solution and the medicinal solution is sucked (drawn) into a syringe for use. In this case, in order to obtain the medicinal solution, by using an instrument provided with a double-ended needle, a plug member (rubber plug) of a medicinal agent container containing a solid or liquid medicinal agent and having a negative pressure in the interior thereof is stuck (pierced) by one end of the double-ended needle and is connected thereto, and a plug member of a liquid container containing liquid such as distilled water is stuck (pierced) by the other end thereof and is connected thereto, whereby the medicinal agent container and the liquid container are brought into communication with each other. Then, since the interior of the medicinal agent container has a negative pressure, the liquid in the liquid container is drawn toward the medicinal agent container, passes through the double-ended needle, and flows into the medicinal agent container. Subsequently, the medicinal agent container is shaken several times. Accordingly, the medicinal agent in the medicinal agent container is diluted or dissolved by the liquid flowed therein.

Examples of patent literature which disclose related art directed to an instrument for mixing a medicinal agent and liquid by using a double-ended needle include JP-A-2001-333961 and Japanese Patent No.3590401.

When shaking the above-described medicinal agent container for mixing the medicinal agent and the liquid in the medicinal agent container, the medicinal agent container and the liquid container are in communication with each other via a lumen in the double-ended needle. Therefore, a solution in the medicinal agent container may flow reversely into the liquid container through the lumen in the double-ended needle. When such a reverse flow of the solution occurs, the amount of the solution (coordinated medicinal solution) in the medicinal agent container is reduced. In other words, the amount of medicinal solution that can be used is reduced. Furthermore, there is a possibility that a desired effect is not achieved due to a change of the concentration of the solution.

In view of such circumstances, it would be advantageous to provide a double-ended needle and a mixing instrument which is capable of suppressing a reverse flow of a solution.

### SUMMARY

An exemplary embodiment of the disclosure here provides a double-ended needle used in a mixing instrument configured to mix a first component and a liquid second component, including: a first puncture portion capable of sticking into a first container in which the first component is contained; and a second puncture portion capable of sticking into a second container in which the second component is contained, wherein an inner cavity of the first puncture portion and an inner cavity of the second puncture portion are in communication with each other, and the lateral cross-sectional area of the inner cavity of the first puncture portion is smaller than the lateral cross-sectional area of the inner cavity of the second puncture portion.

According to the disclosure configured as described above, since the lateral cross-sectional areas of the inner cavity of the first puncture portion is smaller than the lateral cross-sectional area of the inner cavity of the second puncture portion, the solution (mixed liquid) in the interior of the first container can hardly (barely) flow into the inner cavity of the first puncture portion when transferring the second component from the second container to the first container via the double-ended needle and mixing the first component with the second component in the interior of the first container. Therefore, the reverse flow of the solution from the first container to the second container may be suppressed.

In the double-ended needle described above, preferably, an inner cavity of the double-ended needle is reduced gradually from the second puncture portion to the first puncture portion.

In this configuration, the inner cavity of the double-ended needle is the thinnest at a distal end opening of the first puncture portion and the thickest at a distal end opening of the second puncture portion. Therefore, the reverse flow of the solution from the first container to the second container may be effectively suppressed even further. Also, since the inner cavity of the double-ended needle is formed into a tapered shape from the second puncture portion toward the first puncture portion and has a simple shape, manufacture of the double-ended needle is easy.

In the exemplary embodiment of the double-ended needle described above, a ratio (d1/d2) between an inner diameter d1 of the thinnest portion of the inner cavity of the first puncture portion and an inner diameter d2 of the thickest portion of the inner cavity of the second puncture portion is preferably 0.25 to 0.85.

In this configuration, the reverse flow of the solution from the second container to the first container may be effectively suppressed.

In the double-ended needle described above, the ratio (d1/d2) between the inner diameter dl of the thinnest portion of the inner cavity of the first puncture portion and the inner diameter d2 of the thickest portion of the inner cavity of the second puncture portion is more preferably 0.5 to 0.7.

In this configuration, the reverse flow of the solution from the second container to the first container may be further effectively suppressed.

In the double-ended needle described above, preferably, an outer diameter of the first puncture portion and an outer diameter of the second puncture portion are the same.

In this exemplary configuration, a thrust resistance value of the first puncture portion into the first container and a thrust resistance value of the second puncture portion into the second container may be set to the substantially same value. Therefore, since the first puncture portion and the second puncture portion may be stuck respectively into the first container and the second container substantially simultaneously, problems such as leakage of liquid at the time of communication and release of a negative pressure in the first container to the atmosphere may be prevented.

A further exemplary embodiment of the disclosure herein provides a mixing instrument for mixing a first component and a liquid second component, including: a first container containing the first component and having a state of negative pressure in the interior thereof; a second container containing the second component; and a double-ended needle having a first puncture portion to be stuck into the first container and a second puncture portion to be stuck into the second container, wherein an inner cavity of the first puncture portion and an inner cavity of the second puncture portion are in communication with each other, and the lateral cross-sectional area of the inner cavity of the first puncture portion is smaller than the lateral cross-sectional area of the inner cavity of the second puncture portion.

In the mixing instrument described above, preferably, an inner cavity of the double-ended needle is reduced gradually from the second puncture portion to the first puncture portion.

In the exemplary embodiment of the mixing instrument described above, the ratio (d1/d2) between an inner diameter dl of the thinnest portion of the inner cavity of the first puncture portion and an inner diameter d2 of the thickest portion of the inner cavity of the second puncture portion is preferably 0.25 to 0.85.

Still further, in the mixing instrument described above, the ratio (d1/d2) between the inner diameter dl of the thinnest portion of the inner cavity of the first puncture portion and the inner diameter d2 of the thickest portion of the inner cavity of the second puncture portion is more preferably 0.5 to 0.7.

In the exemplary embodiment of the mixing instrument described above, preferably, an outer diameter of the first puncture portion and an outer diameter of the second puncture portion are the same.

Hence, according to the exemplary embodiment of the double-ended needle and the mixing instrument of the disclosure here, the reverse flow of the solution may be prevented.

### BRIEF DESCRIPTION OF DRAWINGS

The accompanying drawings are included in the specification and form a part of the disclosure here, and are used to disclose aspects and principles of the disclosure here together with the detailed description set forth below.

FIG. 1 is an exploded perspective view of a mixing instrument according to a first exemplary embodiment of the disclosure.

FIG. 2 is a vertical cross-sectional view of the mixing instrument illustrated in FIG. 1.

FIG. 3A is a partly omitted vertical cross-sectional view of a double-ended needle which constitutes part of the mixing instrument illustrated in FIG. 1 and a portion in the periphery thereof, and FIG. 3B is a partly omitted vertical cross-sectional view of the double-ended needle according to a modification and the portion in the periphery thereof.

FIG. 4 is a vertical cross-sectional view for explaining a method of usage of the mixing instrument illustrated in FIG. 1, illustrating a state in which a connector is mounted on a medicinal agent container holder.

FIG. 5 is a vertical cross-sectional view for explaining a method of usage of the mixing instrument illustrated in FIG. 1, illustrating a state in which the double-ended needle penetrates through a first plug member and a second plug member and the medicinal agent container and the liquid container are brought into communication with each other.

FIG. 6 is a drawing illustrating a test result confirming an effect of reverse flow prevention by the exemplary embodiment of the double-ended needle according to the disclosure.

### DETAILED DESCRIPTION

Referring now to the attached drawings, a double-ended needle and a mixing instrument according to the disclosure here will be described with reference to exemplary embodiments, that is embodiments representing examples of the double-ended needle and mixing instrument disclosed here.

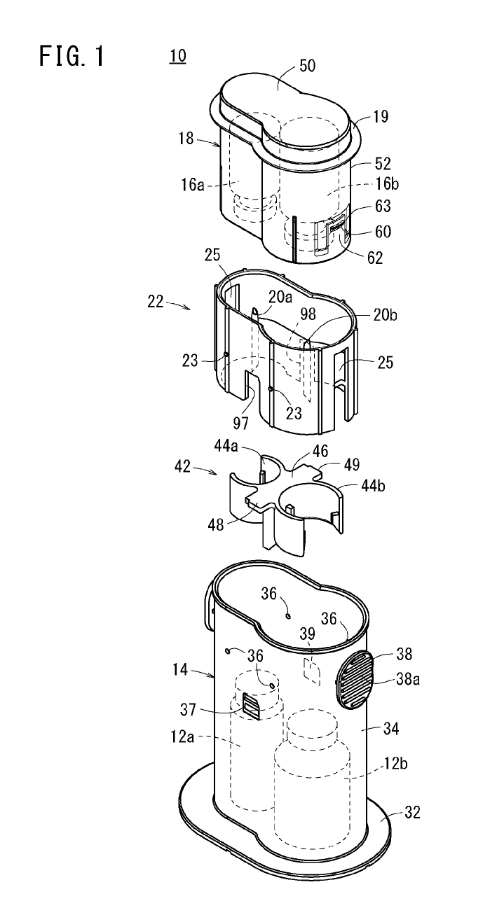

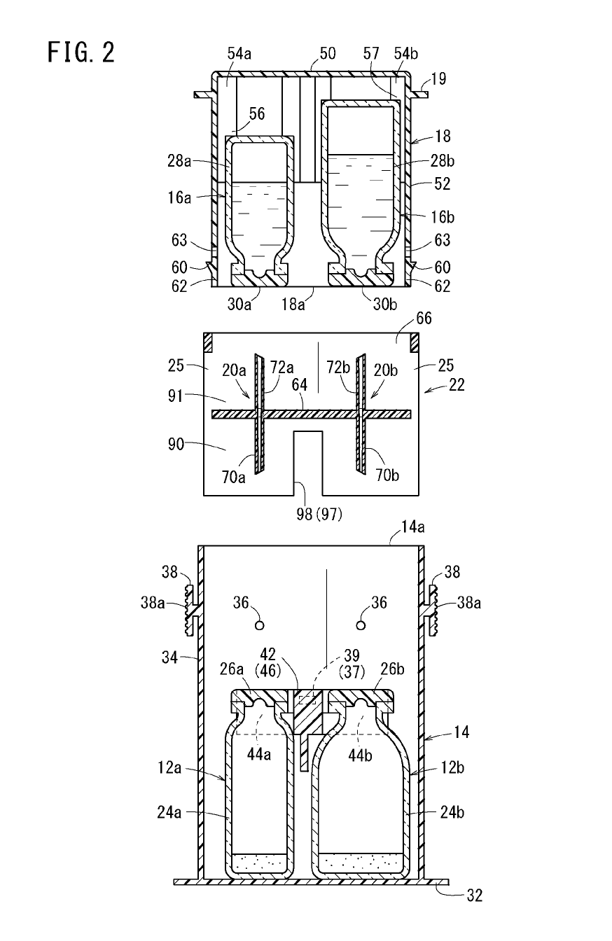

FIG. 1 is an exploded perspective view illustrating a mixing instrument 10 according to an exemplary embodiment of the disclosure herein. FIG. 2 is an exploded vertical cross-sectional view illustrating the mixing instrument 10. The mixing instrument 10 is for mixing a first component and a second component. The first component is in a solid state, liquid state, or gel state. The second component is in a liquid state.

As illustrated in FIG. 1 and FIG. 2, the mixing instrument 10 includes two medicinal agent containers (first containers) 12a, 12b containing the first component, a medicinal agent holder 14 (first holder) to which the two medicinal agent containers 12a, 12b are mounted, two liquid containers (second containers) 16a, 16b containing the second component, a liquid container holder (second holder) 18 to which the two liquid containers 16a, 16b are mounted, and a connector 22 having two double-ended needles 20a, 20b for bringing the medicinal agent containers 12a, 12b and the liquid containers 16a, 16b into communication with each other.

The medicinal agent containers 12a, 12b and the liquid containers 16a, 16b are not specifically limited. However, for example, a vial bottle (vial) or the like may be used.

The medicinal agent containers 12a, 12b preferably contain a medicinal agent as the first component, and the interiors thereof have a negative pressure. The form of the medicinal agent is not specifically limited and, for example, solid state (tablets, granulates and the like), powder (powdered drug and the like), liquid (liquid medicine and the like) are exemplified. When dispensing a body tissue adhesive agent, examples of the medicinal agent include, for example, thrombin or fibrinogen. When dispensing an adhesion prevention agent, examples of the medicinal agent include carboxymethyl-dextrin modified by Succinimidyl group or a mixture of sodium hydrogen carbonate and sodium carbonate. A medicinal agent to be contained in the one medicinal agent container 12a and a medicinal agent to be contained in the other medicinal agent container 12b may be the same or different from each other.

Since the medicinal agent containers 12a, 12b have a substantially equivalent configuration except that the size and the shape may be different, the one medicinal agent container 12a will be described below as a representative with “a” added to the reference signs (numerals), and the other medicinal agent container 12b is represented with “b” added to the reference signs (numerals) of corresponding components of the one medicinal agent container, and a detailed description thereof will be omitted. The two medicinal agent containers 12a, 12b may also be configured to have the same size and shape as a matter of course.

The medicinal agent container 12a includes a, preferably hard, container body 24a and a first plug member 26a formed of an elastic material and configured to seal a port of the container body 24a in an air-tight manner.

The constituent material of the container body 24a is not specifically limited and, for example, various types of glass or various types of resins such as polyvinyl chloride, polyethylene, polypropylene, cyclic polyolefin, polystyrene, poly-(4-methyl penten-1), polycarbonate, an acrylic resin, acrylonitrile-butadiene-styrene copolymer, polyester such as polyethylene terephthalate and polyethylene naphthalate, butadiene-styrene copolymer, polyamide (for example, nylon 6, nylon 6.6, nylon 6.10, and nylon 12) are exemplified.

When comparing the glass and the resin, the resin is preferable because when the container body 24a is formed of a resin, disposal by burning is possible and additional time and effort required for disposal is alleviated. The container body 24a preferably has light-transmissivity (substantially transparent or translucent) in order to obtain visibility of the interior.

The first plug member 26a allows sticking by first puncture portions 70a, 70b, described later. The material for first plug member 26a is not specifically limited, and examples of the material include elastic materials such as, for example, various types of rubber materials including natural rubber, butyl rubber, isoprene rubber, butadiene rubber, styrene-butadiene rubber, silicone rubber, polyurethane-based, polyester-based, polyamide-based, olefin-based, and styrene-based various thermoplastic elastomers, and a mixtures thereof. The elastic material may also be laminated.

The liquid to be contained in the liquid containers 16a, 16b is liquid for diluting or dissolving the medicinal agent, for example, distillated water or the like. The liquid containers 16a, 16b have a configuration substantially equivalent to the medicinal agent containers 12a, 12b except that the size and shape may be different, and include a, preferably hard, container body 28a, 28b, and second plug members 30a, 30b formed of an elastic material that seals ports of the container body 28a, 28b in an air-tight manner. The size and the shape of the two liquid containers 16a, 16b may be different from each other, or may be the same.

Subsequently, a configuration of the medicinal agent holder 14 will be described. The medicinal agent holder 14 is a bottomed cylindrical component in which the medicinal agent container 12 is stored, and includes a bottom portion 32 and a side wall portion 34 extending upward from the bottom portion 32. A first opening 14a is formed at one end portion (upper end) of the medicinal agent holder 14 so that the medicinal agent containers 12a, 12b are configured to be inserted (stored) in the medicinal agent holder 14 through the first opening 14a.

The side wall portion 34 is provided with a plurality of (four in the illustrated example) first engaging holes 36 at a position near upper portions of front and rear wall portions opposing each other, and further with second engaging holes 37, 39 near the centers in the height direction and near the centers in the lateral direction of the front and rear wall portions at positions facing each other. Pressed portions 38 to be pressed by fingers are provided in the vicinities of the upper portions on both the left and right sides of the side wall portion 34. A plurality of ribs (projections) 38a for preventing slippage are provided on the surfaces of the pressed portions 38.

Examples of the material of the medicinal agent holder 14 include various types of glass or various types of resins such as polyvinyl chloride, polyethylene, polypropylene, cyclic polyolefin, polystyrene, poly-(4-methyl penten-1), polycarbonate, an acrylic resin, acrylonitrile-butadiene-styrene copolymer, polyester such as polyethylene terephthalate and polyethylene naphthalate, butadiene-styrene copolymer, polyamide (for example, nylon 6, nylon 6.6, nylon 6.10, and nylon 12).

A constraint member (medicinal agent container neck holder) 42 for constraining (fixing) the medicinal agent container(s) 12a, 12b with respect to the medicinal agent holder 14 is provided in the interior of the medicinal agent holder 14. The constraint member 42 includes a C-shaped pair of holding portions 44a, 44b arranged in an orientation back to back with each other, a coupling portion 46 configured to couple the pair of holding portions 44a, 44b to each other, and a pair of engaging strips (projections) 48, 49 projecting from the coupling portion 46 in both outward directions orthogonal to the direction of array of the pair of holding portions 44a, 44b.

The one holding portion 44a is configured to be capable of holding a neck portion (nipped-in portion) of the one medicinal agent container 12a, and the other holding portion 44b is configured to be capable of holding a neck portion of the other medicinal agent container 12b. The medicinal agent containers 12a, 12b are fixed with respect to the medicinal agent holder 14 at predetermined positions by holding the respective neck portions of the medicinal agent containers 12a, 12b being held by the holding portions 44a, 44b and by the second engaging holes 37, 39 provided on the medicinal agent holder 14 engaging the pair of engaging strips 48, 49.

Another exemplary configuration in which depressions are provided at a corresponding position on an inner wall surface of the medicinal agent holder 14 instead of the second engaging holes 37, 39, and the engaging strips 48, 49 engage with the depressions is also applicable. The constituent material of the constraint member 42 may be the same as those exemplified as the constituent materials of the medicinal agent holder 14 described above.

A configuration of the liquid container holder 18 will now be described. The liquid container holder 18 is a cylindrical component configured to contain the two liquid containers 16a, 16b, and includes a top portion 50, and a side wall portion 52 extending downward from the top portion 50. The height of the side wall portion 52 is set so that the liquid containers 16a, 16b are completely contained in the interior of the liquid container holder 18. Rib-shaped supporting guides 54a, 54b for supporting the two liquid containers 16a, 16b respectively are provided on an inner peripheral surface of the side wall portion 52. The respective supporting guides 54a, 54b are provided with shoulders 56, 57 for controlling the depth of insertion of the liquid containers 16a, 16b.

A second opening 18a is formed at one end portion (lower end) of the liquid container holder 18, so that the liquid containers 16a, 16b are configured to be inserted in the liquid container holder 18 through the second opening 18a. A flange portion 19 extending around an outer peripheral portion of the liquid container holder 18 is provided in the vicinity of an upper portion of the liquid container holder 18.

A pair of arms 62 each including a claw 60 and being elastically displaceable are provided on the left and right of the outer peripheral portion of the liquid container holder 18. The pair of arms 62 are configured as elastic strips extending upward from a lower portion of a side opening 63 provided in the vicinity of the lower portion (in the vicinity of the second opening 18a) of left and right side walls of the liquid container holder 18. The claws 60 are formed so as to project from outer surfaces of the arms 62 in the vicinity of distal ends thereof in the vicinity of an upper end portion.

A configuration of the connector 22 will now be described. The connector 22 includes a partitioning plate 64 extending in the horizontal direction, a side wall 66 extending upward and downward from a peripheral edge of the partitioning plate 64, and two of the double-ended needles 20a, 20b projecting upward and downward from the partitioning plate 64.

The two double-ended needles 20a, 20b are provided in parallel to each other at positions spaced from each other in the horizontal direction. The double-ended needles 20a, 20b respectively include the first puncture portions 70a, 70b configured to be stuck into the first plug members 26a, 26b, and second puncture portions 72a, 72b configured to be stuck into the second plug members 30a, 30b.

Two of the first puncture portions 70a, 70b project downward from a lower surface of the partitioning plate 64, and two of the second puncture portions 72a, 72b project upward from an upper surface of the partitioning plate 64. The constituent material of the double-ended needles 20a, 20b may be the same as the constituent material of the medicinal agent holder 14 described above.

In the configuration example illustrated in the drawing, the partitioning plate 64, the side wall 66, and the double-ended needles 20a, 20b are integrally formed. However, the configuration is not limited to such a configuration, and a configuration in which the double-ended needles 20a, 20b are formed of a metal such as stainless (including alloy) and joined to the partitioning plate 64 formed of a resin material by adhesion or welding or the like is also applicable.

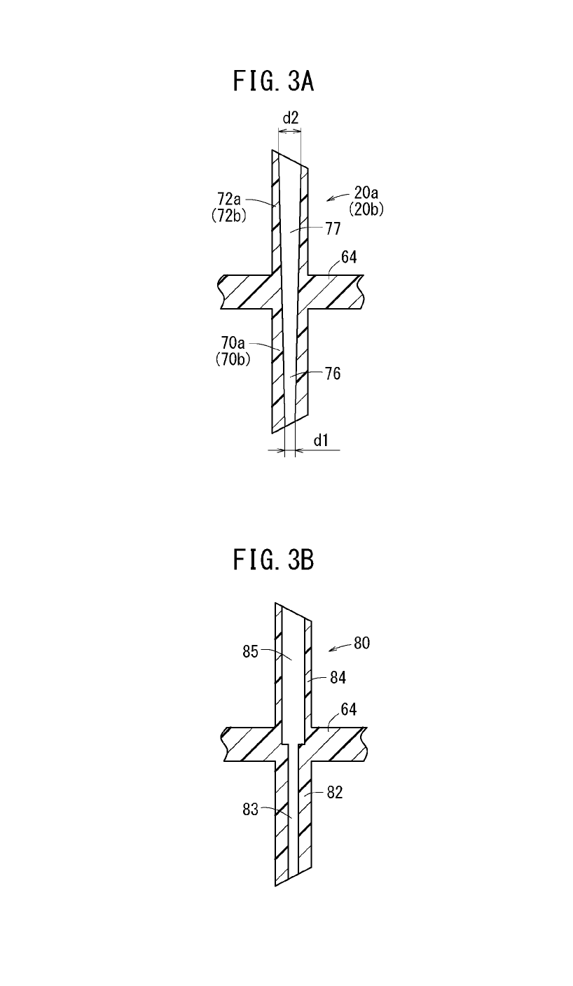

FIG. 3A is a partly omitted vertical cross-sectional view of the double-ended needle 20a and a peripheral portion thereof. In the following description, a configuration of the one double-ended needle 20a will be described. However, the other double-ended needle 20b has the same configuration as the one double-ended needle 20a. As illustrated in FIG. 3A, an inner cavity 76 of the first puncture portion 70a and an inner cavity 77 of the second puncture portion 72a communicate with each other. The lateral cross-sectional area of the inner cavity 76 of the first puncture portion 70a is set to be smaller than the lateral cross-sectional area of the inner cavity 77 of the second puncture portion 72a.

In the case of the double-ended needle 20a illustrated in FIG. 3A, the cross section of an inner cavity of the double-ended needle 20a is a circular shape, and an inner diameter of the inner cavity 76 of the first puncture portion 70a is smaller than an inner diameter of the inner cavity 77 of the second puncture portion 72a. More specifically, the inner cavity of the double-ended needle 20a is reduced in diameter in a tapered shape from the second puncture portion 72a to the first puncture portion 70a. Therefore, an inner diameter of the inner cavity of the double-ended needle 20a is the smallest at a distal end opening of the inner cavity 76 of the first puncture portion 70a, and is the largest at a distal end opening of the inner cavity 77 of the second puncture portion 72a.

An inner diameter of the thinnest portion of the inner cavity 76 of the first puncture portion 70a is defined as d1, and an inner diameter of the thickest portion of the inner cavity 77 of the second puncture portion 72a is defined as d2. In this case, the ratio (d1/d2) between the inner diameter dl and the inner diameter d2 is preferably 0.25 to 0.85 and, more preferably, 0.5 to 0.7. The reason will be described later.

An outer diameter of the first puncture portion 70a and an outer diameter of the second puncture portion 72a are set to be the same. Accordingly, a thrust resistance value of the first puncture portions 70a, 70b into the first plug members 26a, 26b and a thrust resistance value of the second puncture portions 72a, 72b into the second plug members 30a, 30b may be set to the substantially same value. Therefore, when pressing the liquid container holder 18 into communication, the first puncture portions 70a, 70b and the second puncture portions 72a, 72b may be stuck into the first plug members 26a, 26b and the second plug members 30a, 30b respectively, so that problems such as leakage of liquid at the time of communication and release of the negative pressures in the medicinal agent containers 12a, 12b to the atmosphere may be prevented.

A further exemplary configuration is shown in FIG. 3B, in which a double-ended needle 80 has an inner cavity 83 of a first puncture portion 82 is set to be constant in the axial direction, an inner cavity 85 of a second puncture portion 84 is set to be constant in the axial direction, and an inner diameter of the inner cavity 83 of the first puncture portion 82 is set to be smaller than an inner diameter of the inner cavity 85 of the second puncture portion 84. Use of double-ended needle 80 as illustrated in FIG. 3B instead of the double-ended needle 20a illustrated in FIG. 3A is also applicable.

As illustrated in FIG. 1 and FIG. 2, a portion of the side wall 66 of the connector 22 lower than the partitioning plate 64 (hereinafter, referred to as a lower side wall 90) is formed so as to surround collectively the first puncture portions 70a, 70b. The height (vertical dimension) of the lower side wall 90 is set to be longer than the height of the two first puncture portions 70a, 70b so that the distal ends (blade edge) of the first puncture portions 70a, 70b do not project downward from a lower end of the lower side wall 90.

Notched portions 97, 98 are formed on wall portions of the lower side wall 90 extending in the direction in which the double-ended needles 20a, 20b are apart (the lateral direction), opening downwards, and facing each other so as to penetrate through the connector 22 between an interior and an exterior thereof. The width of the notched portions 97, 98 (the size in the direction in which the double-ended needles 20a, 20b are apart) is larger than the width of the pair of engaging strips 48, 49 of the constraint member 42.

A portion of the side wall 66 higher than the partitioning plate 64 (hereinafter, referred to as an upper side wall 91) is formed so as to surround collectively the second puncture portions 72a, 72b. The height of the upper side wall 91 is set to be longer than the height of the two second puncture portions 72a, 72b so that the distal ends (blade edges) of the two second puncture portions 72a, 72b do not project upward from the upper end of the upper side wall 91. Windows 25 are provided in wall portions of the upper side wall 91 which constitute end portions of the upper side wall 91 in the direction in which the double-ended needles 20a, 20b are apart (the lateral direction) and penetrate therethrough in a direction of the thickness of the wall portion.

The connector 22 may be inserted into the medicinal agent holder 14 with an inner peripheral surface of the side wall 66 of the medicinal agent holder 14 used as a sliding surface. The liquid container holder 18 may be inserted into the connector 22 with an outer peripheral surface of a lower end portion used as a sliding surface.

The mixing instrument 10 according to this exemplary embodiment is basically configured as described above. The operation and the effects thereof will be described below.

As illustrated in FIG. 2, the medicinal agent containers 12a, 12b are contained in the medicinal agent holder 14 in a manner such that the medicinal agent containers 12a, 12b are fixed to the medicinal agent holder 14 by the constraint member 42. The liquid containers 16a, 16b are mounted on the liquid container holder 18 in a manner such that the liquid containers 16a, 16b are held by the liquid container holder 18.

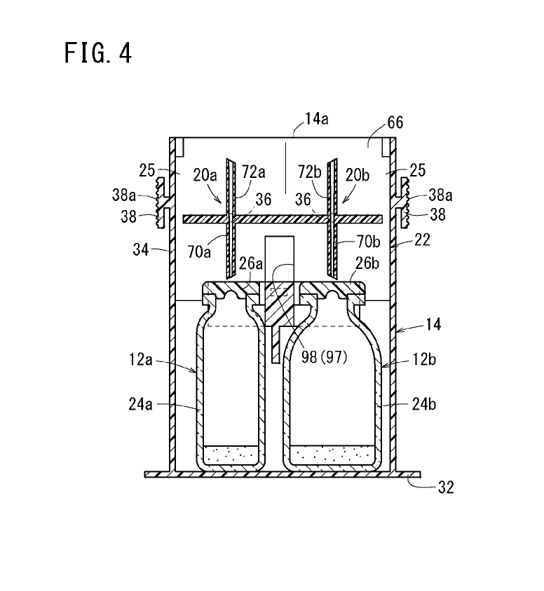

As illustrated in FIG. 4, the connector 22 with the first puncture portions 70a, 70b directed toward the medicinal agent containers 12a, 12b is inserted into the medicinal agent holder 14. At this time, a plurality of engaging projections 23 provided on an outer peripheral portion of the connector 22 are caught by a respective first engaging hole 36 provided in the medicinal agent holder 14, whereby the connector 22 is temporarily held at a predetermined position in the medicinal agent holder 14. In this a state, the second puncture portions 72a, 72b are not in contact with the first plug members 26a, 26b of the medicinal agent containers 12a, 12b.

Subsequently, the liquid container holder 18 on which the liquid containers 16a, 16b are mounted is inserted into the connector 22 in a state in which the second plug members 30a, 30b are directed toward the second puncture portions 72a, 72b. In this case, the second puncture portions 72a, 72b are pressed by the second plug members 30a, 30b of the liquid containers 16a, 16b, and a pressing force toward the medicinal agent containers 12a, 12b is applied on the connector 22.

Then, when the pressing force exceeds an engaging force between the engaging projections 23 and the first engaging holes 36, the engagement between the engaging projections 23 and the first engaging holes 36 is released, so that the connector 22 moves toward the medicinal agent containers 12a, 12b. At this time, the holding portions 44a, 44b of the constraint member 42 are inserted into the inside of the lower side wall 90 of the connector 22. In so doing, the engaging strips 48, 49 of the constraint member 42 enter the notched portions 97, 98 provided on the lower side wall 90 of the connector 22. Therefore, the movement of the connector 22 toward the medicinal agent containers 12a, 12b is not hindered by the constraint member 42.

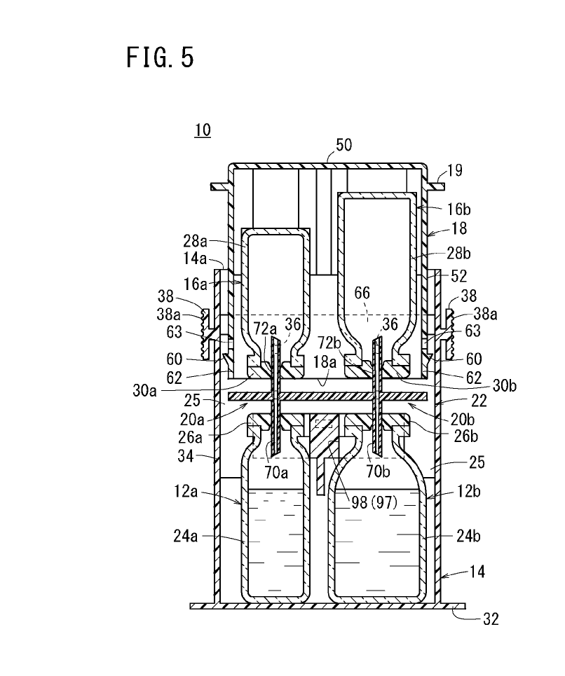

When the liquid containers 16a, 16b are pushed further toward the medicinal agent containers 12a, 12b, the first puncture portions 70a, 70b are stuck through (penetrated through) the first plug members 26a, 26b of the medicinal agent containers 12a, 12b, and the second puncture portions 72a, 72b are stuck through the second plug members 30a, 30b of the liquid containers 16a, 16b as illustrated in FIG. 5. In other words, needle points of the first puncture portions 70a, 70b pierce the first plug members 26a, 26b and enter the interiors of the medicinal agent containers 12a, 12b, and needle points of the second puncture portions 72a, 72b pierce the second plug members 30a, 30b and enter the interiors of the liquid containers 16a, 16b. Accordingly, the two medicinal agent containers 12a, 12b and the two liquid containers 16a, 16b are brought into the state of being in communication with each other by the corresponding double-ended needles 20a, 20b.

Further, in the course in which the liquid containers 16a, 16b are inserted into the connector 22, the arms 62 are elastically deformed inward of the connector 22 by being pressed by the side wall 66 of the connector 22. When the claws 60 of the liquid container holder 18 climb over the side wall 66 of the connector 22 and reach the windows 25 provided on the both left and right sides of the connector 22, the claws 60 are caught by edges of the windows 25 from the inside. Accordingly, the liquid container holder 18 and the connector 22 are fixed. In other words, the connector 22 is brought into a state where it is incapable of being removed from the liquid container holder 18. At this time, the medicinal agent holder 14 in which the medicinal agent containers 12a, 12b are contained, the liquid container holder 18 in which the liquid containers 16a, 16b are contained, and the connector 22 are connected to each other, so that the mixing instrument 10 assumes an assembled state.

Since the interiors of the medicinal agent containers 12a, 12b have a negative pressure, when the interiors of the medicinal agent containers 12a, 12b and the interiors of the liquid containers 16a, 16b are brought into a communicating state by the double-ended needles 20a, 20b stuck therethrough, the liquid in the respective liquid containers 16a, 16b is sucked (drawn) toward the medicinal agent containers 12a, 12b, and hence the liquid flows into the interiors of the medicinal agent containers 12a, 12b respectively through the double-ended needles 20a, 20b. When the movement of the liquid from the liquid containers 16a, 16b to the medicinal agent containers 12a, 12b is completed, the mixing instrument 10 is shaken several times. Accordingly, the medicinal agent in the respective medicinal agent containers 12a, 12b is diluted or dissolved by the liquid having flowed therein.

In this case, since the lateral cross-sectional areas of the inner cavities 76 of the first puncture portions 70a, 70b are set to be smaller than the lateral cross-sectional areas of the inner cavities 77 of the second puncture portions 72a, 72b, the solution (mixed liquid) in the medicinal agent containers 12a, 12b can hardly flow into the inner cavities 76 of the first puncture portions 70a, 70b. Therefore, the reverse flow of the solution from the medicinal agent containers 12a, 12b to the liquid containers 16a, 16b may be adequately suppressed.

When the mixture of the medicinal agent and the liquid is completed, the liquid container holder 18 is pulled in the direction of pulling out from the medicinal agent holder 14. Since the claws 60 of the liquid container holder 18 are caught by the windows 25 of the connector 22, the liquid container holder 18 in which the liquid containers 16a, 16b are contained can be separated (taken out) from the medicinal agent holder 14 together with the connector 22. In this case, since the flange portion 19 is provided on an outer periphery in the vicinity of the upper portion of the liquid container holder 18, the liquid container holder 18 can be easily pulled out by the user grasping the flange portion 19 with his fingers.

As described thus far, according the double-ended needles 20a, 20b and the mixing instrument 10 of this exemplary embodiment, since the lateral cross-sectional areas of the inner cavities 76 of the first puncture portions 70a, 70b are smaller than the lateral cross-sectional areas of the inner cavities 77 of the second puncture portions 72a, 72b, the solution (mixed liquid) in the interiors of the medicinal agent containers 12a, 12b can hardly (minimally) flow into the inner cavities 76 of the first puncture portions 70a, 70b when transferring the liquid from the liquid containers 16a, 16b to the medicinal agent containers 12a, 12b via the double-ended needles 20a, 20b, and mixing the liquid with the medicinal agent in the interior of the medicinal agent containers 12a, 12b. Therefore, the reverse flow of the solution from the medicinal agent containers 12a, 12b to the liquid containers 16a, 16b may be restrained while obtaining movement of the liquid from the liquid containers 16a, 16b to the medicinal agent containers 12a, 12b.

When configured so that the inner diameter is decreased gradually from the second puncture portions 72a, 72b to the first puncture portions 70a, 70b as the double-ended needles 20a, 20b illustrated in FIG. 3A, the inner cavities of the double-ended needles 20a, 20b become the thinnest at the distal end openings of the second puncture portions 72a, 72b and the thickest at the distal end openings of the first puncture portions 70a, 70b. Therefore, the reverse flow of the solution from the medicinal agent containers 12a, 12b to the liquid containers 16a, 16b may be more effectively suppressed. Furthermore, the inner cavities of the double-ended needles 20a, 20b being formed into a shape tapered from the second puncture portions 72a, 72b to the first puncture portions 70a, 70b is a simple shape, and manufacture of the double-ended needles 20a, 20b is therefore easily accomplished.

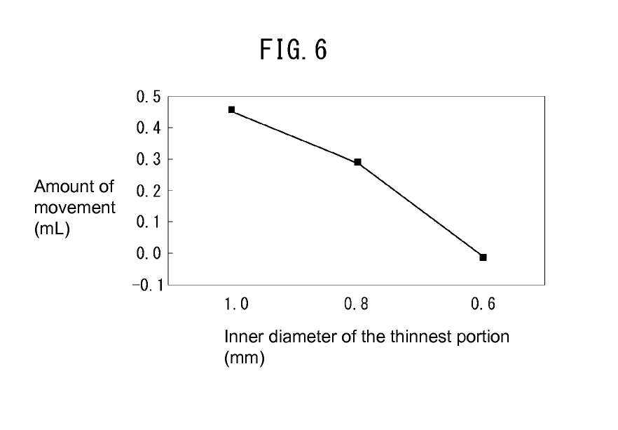

FIG. 6 illustrates a test result for confirming an effect of reverse flow prevention by the double-ended needle 20a (20b, 80) according to the exemplary embodiments of the disclosure. In this test, the amount of reverse flow was measured for cases where the inner diameter d2 of the thickest portion of the inner cavity 77 of the second puncture portion 72a was set to 1.2 mm, and the inner diameter d1 of the thinnest portion of the inner cavity 76 of the first puncture portion 70a was set to be 1.0 mm, 0.8 mm, and 0.6 mm, respectively. The viscosity of the liquid used was 0.5 to 5.0 mPa·s (actual measurement; approximately 1.8 mPa·s).

In FIG. 6, the “inner diameter of the thinnest portion” of the lateral axis means the inner diameter d1, and the “amount of movement” of the vertical axis means the amount of reverse flow. As illustrated in FIG. 6, the smaller the inner diameter dl was, that is, the smaller the inner diameter ratio d1/d2 was, the more the amount of reverse flow of the solution was reduced, and hence the high effect of the reverse flow prevention was obtained. Specifically, when the inner diameter dl was 1.0 mm (inner diameter ratio d1/d2≈0.83), the amount of reverse flow of the solution was 0.46 mL, when the inner diameter dl was 0.8 mm (when the inner diameter ratio d1/d2≈0.66), the amount of reverse flow of the solution was 0.29 mL, and when the inner diameter dl was 0.6 mm, (when the inner diameter ratio d1/d2=0.5), the amount of reverse flow of the solution was 0.

In view of the results described above, when the inner diameter ratio between the inner diameter dl and the inner diameter d2 (d1/d2) is 0.5 to 0.7, the effect of suppressing the reverse flow of the solution from the medicinal agent containers 12a, 12b to the liquid containers 16a, 16b is ensured. Also, when the inner diameter ratio between the inner diameter dl and the inner diameter d2 (d1/d2) is on the order of 0.25 to 0.85, the effect of suppressing the reverse flow of the solution from the medicinal agent containers 12a, 12b to the liquid containers 16a, 16b may be expected. When the inner diameter ratio (d1/d2) is below 0.25, the inner diameter dl becomes too small, and hence the fluid resistance in the double-ended needles 20a, 20b becomes too large when drawing the liquid from the liquid containers 16a, 16b toward the medicinal agent containers 12a, 12b, so that a significantly long time is required for transferring the liquid from the liquid containers 16a, 16b toward the medicinal agent containers 12a, 12b. When the inner diameter ratio (d1/d2) exceeds 0.85, since the inner diameter dl is substantially the same as the inner diameter d2, the effect of preventing the reverse flow of the solution can generally not be successfully obtained.

When the inner diameter d2 of the thickest portions of the inner cavities 77 of the second puncture portions 72a, 72b is 1.2 mm, the inner diameter dl of the thinnest portions of the inner cavities 76 of the first puncture portions 70a, 70b is preferably 0.3 to 1.0 mm and, more preferably, 0.6 to 0.8 mm.

The reverse flow preventing effect described above may be obtained in the same manner by the configuration of the double-ended needle 80 illustrated in FIG. 3B.

The mixing instrument 10 according to the embodiment described above includes the two medicinal agent containers 12a, 12b and the two liquid containers 16a, 16b and, correspondingly, the two double-ended needles 20a, 20b. However, the disclosure here is not limited thereto, and may be applied to a mixing instrument including only one each of the medicinal agent container, the liquid container, and the double-ended needle.

The detailed description above describes a double-ended needle and mixing instrument disclosed by way of example. The disclosure is not limited, however, to the precise embodiment and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A double-ended needle used in a mixing instrument configured to mix a first component and a liquid second component, comprising:
a first puncture portion capable of sticking into a first container in which the first component is contained; and
a second puncture portion capable of sticking into a second container in which the second component is contained;
wherein an inner cavity of the first puncture portion and an inner cavity of the second puncture portion are in communication with each other, and the lateral cross-sectional area of the inner cavity of the first puncture portion is smaller than the lateral cross-sectional area of the inner cavity of the second puncture portion.

2. The double-ended needle according to claim 1, wherein
an inner cavity of the double-ended needle is reduced gradually from the second puncture portion to the first puncture portion.

3. The double-ended needle according to claim 1, wherein the ratio (d1/d2) between an inner diameter dl of a thinnest portion of the inner cavity of the first puncture portion and an inner diameter d2 of a thickest portion of the inner cavity of the second puncture portion is 0.25 to 0.85.

4. The double-ended needle according to claim 1, wherein a ratio (d1/d2) between the inner diameter dl of a thinnest portion of the inner cavity of the first puncture portion and the inner diameter d2 of a thickest portion of the inner cavity of the second puncture portion is 0.5 to 0.7.

5. The double-ended needle according to claim 1, wherein an outer diameter of the first puncture portion and an outer diameter of the second puncture portion are the same.

6. The double-ended needle according to claim 1, wherein the inner cavity of the first puncture portion is constant in an axial direction, the inner cavity of the second puncture portion is constant in the axial direction, and an inner diameter of the inner cavity of the first puncture portion is smaller than an inner diameter of the inner cavity of the second puncture portion.

7. A mixing instrument for mixing a first component and a liquid second component, comprising:
a first container containing the first component and having a state of negative pressure in the interior thereof;
a second container containing the second component; and
a double-ended needle having a first puncture portion configured to be stuck into the first container and a second puncture portion configured to be stuck into the second container;
wherein an inner cavity of the first puncture portion and an inner cavity of the second puncture portion are in communication with each other, and the lateral cross-sectional area of the inner cavity of the first puncture portion is smaller than the lateral cross-sectional area of the inner cavity of the second puncture portion.

8. The mixing instrument according to claim 7, wherein
an inner cavity of the double-ended needle is reduced gradually from the second puncture portion to the first puncture portion.

9. The mixing instrument according to claim 7, wherein
the ratio (d1/d2) between an inner diameter dl of a thinnest portion of the inner cavity of the first puncture portion and an inner diameter d2 of the thickest portion of the inner cavity of the second puncture portion is 0.25 to 0.85.

10. The mixing instrument according to claim 7, wherein
a ratio (d1/d2) between the inner diameter dl of a thinnest portion of the inner cavity of the first puncture portion and the inner diameter d2 of a thickest portion of the inner cavity of the second puncture portion is 0.5 to 0.7.

11. The mixing instrument according to claim 7, wherein
an outer diameter of the first puncture portion and an outer diameter of the second puncture portion are the same.

12. The mixing instrument according to claim 7, wherein
the inner cavity of the first puncture portion is constant in an axial direction, the inner cavity of the second puncture portion is constant in the axial direction, and an inner diameter of the inner cavity of the first puncture portion is smaller than an inner diameter of the inner cavity of the second puncture portion.

13. The mixing instrument according to claim 7, further comprising:
a first holder configured to secure the first container;
a second holder configured to secure the second container; and
a connector configured to releasably connect the first holder and the second holder.

14. The mixing instrument according to claim 13, further comprising:
a constraint member disposed in an interior of the first holder for securely holding the first container with respect to the first holder.

15. The mixing instrument according to claim 13, wherein
the first container includes a first plug member and the second container includes a second plug member;
the first puncture portion configured to pierce the first plug member in the first container and the second puncture portion configured to pierce the second plug member in the second container.

16. The mixing instrument according to claim 15, wherein
the connector includes a partitioning plate, and the double-ended needle is mounted in the partitioning plate such that the first puncture portion is directed toward the first container and the second puncture portion is directed toward the second container.

17. The mixing instrument according to claim 16, wherein
the second holder securing the second container is configured to slide into an upper opening of the connector.

18. The mixing instrument according to claim 17, wherein
the first holder includes a plurality of holes and the connector includes a plurality of projections such that, when the connector slides into an upper opening of the first holder, the projections are engaged with the holes to temporarily hold the connector at a predetermined position in the first holder, and
the second puncture portion is not in contact with the first plug member when the connector is held at the predetermined position.

19. The mixing instrument according to claim 18, wherein
when the second holder securing the second container is pushed toward the first container and a pressing force exceeds an engaging force between the projections and the holes, the connector is configured to move toward the first container such that the first puncture portion pierces the first plug member of the first container and the second puncture portion pierces the second plug member of the second container, thereby establishing mixing between the first component in the first container and the liquid second component in the second container.
